(19) United States
(12) Patent Application Publication
(10) Pub. No.: US 2018/0246846 A1
(43) Pub. Date: Aug. 30, 2018

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: Masafumi Takimoto, Kawasaki-shi (JP)

(21) Appl. No.: 15/903,949

(22) Filed: Feb. 23, 2018

(30) Foreign Application Priority Data
Feb. 27, 2017 (JP) 2017-034901

(51) Int. Cl. G06F 15/18; G06N 3/08; G06T 11/20

(52) U.S. Cl. CPC G06F 15/18; G06T 2207/20081; G06T 11/206; G06N 3/08

(57) ABSTRACT

A technique for displaying information appropriate for causing a highly-precise classifier to learn through processing of causing a classifier to learn interactively with a user. An information processing apparatus includes a class determination unit configured to determine a class to which learning data belongs, based on feature amount of the learning data, a reliability determination unit configured to determine reliability with respect to the class determined by the class determination unit, and a display processing unit configured to display images indicating learning data on a display unit at positions corresponding to the class and the reliability.

### BACKGROUND OF THE INVENTION

### Field of the Invention

The present invention relates to learning of a classifier for identifying data.

### Description of the Related Art

In recent years, there has been put forward various proposals relating to a technique of inputting and classifying high-dimensional feature quantities typified by pattern recognition. Increasing an amount of data to be learned is one of the simplest approaches for improving a recognition precision in machine learning. However, if the amount of data is increased, a wide variety of variations arises into which the data are assorted, so that it will become difficult for a user to instruct a class label.

If a solid standard can be given with respect to the class to be assorted, it is possible to cope with a label fluctuation to a certain extent through a method using a simple noise-robust learning algorithm or a method called “noise-cleansing” which eliminates data having a label without consistency or executes relabeling. In a method discussed in Japanese Patent Application Laid-Open No. 2013-161295, a large volume of data is supervised at low cost, and data which might have an error in the assigned label because of a fluctuation of the evaluation standard are displayed, so that the user is prompted to make a judgement again.

However, for example, if an abnormality type is to be classified with respect to the abnormality occurring at a certain ratio or less although data are regularly in a normal state, types of abnormality occurring in the data may not be predicted in advance. In such a case, the user gradually determines a class while observing how often and what type of the abnormality occurs in the course of data collection.

Specifically, for example, there is a case where a monitoring camera is installed at an intersection, and various abnormal behaviors acquired from moving image data captured by the camera have to be classified into several abnormality types. In this case, it is necessary to supervise abnormality at each type and learn a classifier for assorting a type of abnormality. However, because a type of abnormality occurring at this intersection is unpredictable in advance, it is difficult to define a class as an assortment target when the data does not exist. Therefore, the user has to make a judgement and assign an abnormality type label every time the user looks at the data collected online. Therefore, the user gradually determines a definition of each class while performing a supervising operation.

In order to precisely perform the above-described operation, the user has to refer to or correct a supervising standard assigned in the past, and to perform the supervising operation. Performing such an operation is complicated and troublesome when the data amount is increased. Further, at this time, this label unconformity does not occur as a noise problem. The label unconformity occurs mainly because the user voluntarily changes a judgement standard according to a distribution trend of data. Such an inconsistent supervising operation may lead to a great disadvantage in terms of precision or calculation cost because difficulty of an identification problem will be complicated unnecessarily.

### SUMMARY OF THE INVENTION

The present invention is directed to a technique of displaying information appropriate for learning a highly precise classifier through processing of learning a classifier interactively with a user.

An information processing apparatus according to the present invention includes a class determination unit configured to determine a class to which learning data belong, based on a feature quantity of learning data, a reliability determination unit configured to determine reliability with respect to the class determined by the class determination unit, and a display processing unit configured to display a distribution chart of learning data in which images indicating the learning data are arranged at positions corresponding to the class and the reliability on a display unit.

Further features of the present invention will become apparent from the following description of exemplary embodiments with reference to the attached drawings.

### BRIEF DESCRIPTION OF THE DRAWINGS

FIG. 1 is a block diagram illustrating a hardware configuration of an information processing apparatus.

FIG. 2 is a block diagram illustrating a software configuration of the information processing apparatus.

FIGS. 3A and 3B are diagrams illustrating examples of images as processing targets.

FIG. 4 is a diagram illustrating a state where a generation trend of data becomes visible.

FIG. 5 is a diagram illustrating an example of a distribution chart.

FIG. 6 is a flowchart illustrating learning processing.

FIGS. 7A, 7B, and 7C are diagrams illustrating examples of a distribution chart.

FIG. 8 is a diagram illustrating a display example.

FIGS. 9A, 9B, and 9C are diagrams illustrating examples of a distribution chart of a variation example.

FIGS. 10A and 10B are diagrams illustrating examples of a radar chart.

FIGS. 11A, 11B, 11C, and 11D are diagrams illustrating images of water droplets.

FIGS. 12A and 12B are diagrams illustrating a user operation.

### DESCRIPTION OF THE EMBODIMENTS

Hereinafter, an exemplary embodiment of the present invention will be described with reference to the appended drawings.

An information processing apparatus according to a first exemplary embodiment uses a plurality of data pieces expressed by a plurality of feature quantities as learning data and generates a classifier that identifies a class to which the learning data belong. Further, when the classifier is generated, the information processing apparatus of the present exemplary embodiment visualizes data appropriate for supporting the user operation of assigning labels for assorting data into classes. The present exemplary embodiment will be described while taking captured images of external appearances to be used for automatic appearance inspection as examples of classification target data. Herein, data identified as abnormal data by an abnormal data classifier are further classified into each type of abnormalities.

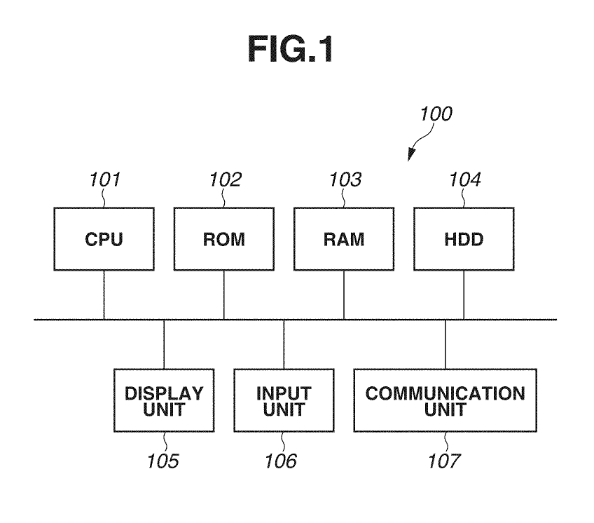

FIG. 1 is a block diagram illustrating a hardware configuration of an information processing apparatus 100 of a first exemplary embodiment. The information processing apparatus 100 includes a central processing unit (CPU) 101, a read only memory (ROM) 102, a random access memory (RAM) 103, a hard disk drive (HDD) 104, a display unit 105, an input unit 106, and a communication unit 107. The CPU 101 reads a control program stored in the ROM 102 to execute various kinds of processing. The RAM 103 is used as a temporary storage area such as a main memory or a work area of the CPU 101. The HDD 104 stores various data or various programs. The CPU 101 reads a program stored in the ROM 102 or the HDD 104 and executes the program to realize the function or processing of the information processing apparatus 100 described below.

The display unit 105 displays various kinds of information. The input unit 106 includes a keyboard or a mouse and receives various operations performed by the user. The communication unit 107 executes processing of communicating with an external apparatus such as an image forming apparatus via a network.

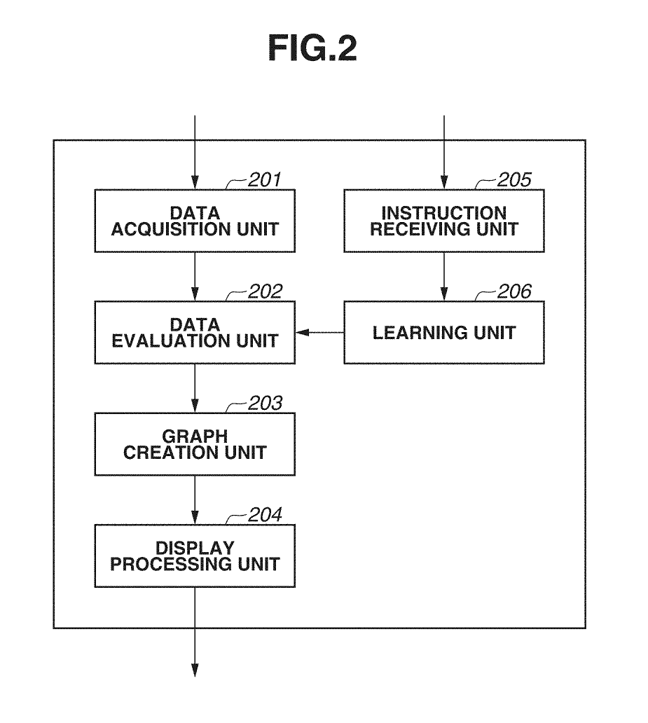

FIG. 2 is a block diagram illustrating a software configuration of the information processing apparatus 100. The information processing apparatus 100 includes a data acquisition unit 201, a data evaluation unit 202, a graph creation unit 203, a display processing unit 204, an instruction receiving unit 205, and a learning unit 206. The processing of respective units will be described below.

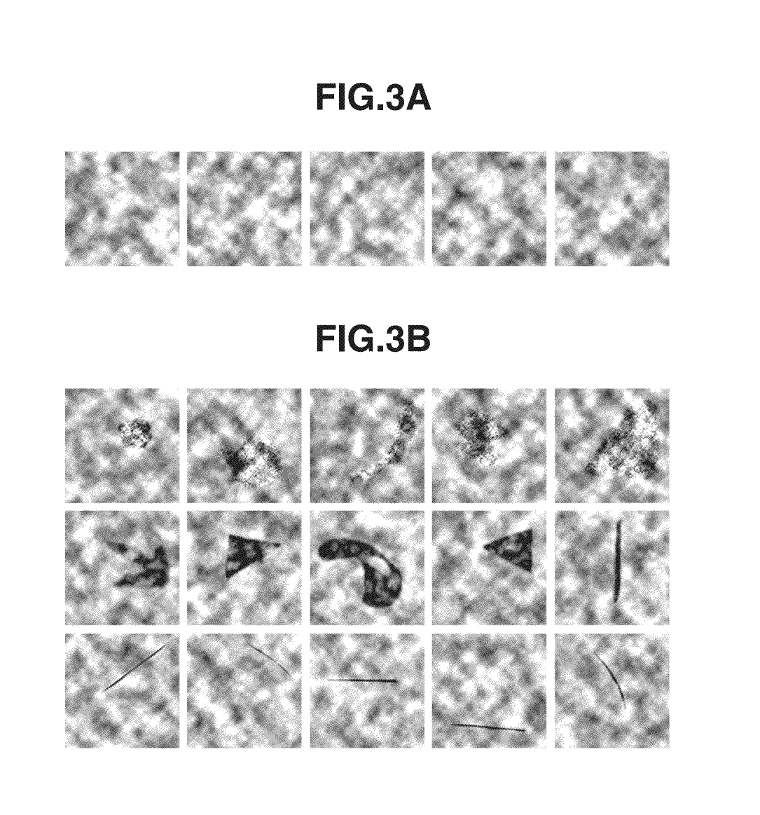

FIGS. 3A and 3B are diagrams illustrating images as processing targets of the information processing apparatus 100 of the present exemplary embodiment. The images illustrated in FIGS. 3A and 3B are captured images of surfaces of products. The images in FIG. 3A are images with uniform textures, and the images in FIG. 3B are images with defective areas such as unevenness or a flaw on the textures illustrated in the images in FIG. 3A. The information processing apparatus 100 executes learning of a classifier which determines the images in FIG. 3A as normal images and the images in FIG. 3B as abnormal images.

Further, at a production site, there is a need of classifying data determined as abnormal data into abnormality types in addition to determining the normal and abnormal labels. It is possible to improve the production efficiency by using a classification result according to the abnormality type as the information for making feedback on design of the production line. When products having a certain type of abnormality are mass-produced drastically, it is often the case that a failure arises in a specific processing. Therefore, the processing failure can be easily identified in real time by classifying the abnormality type.

By collecting and overviewing the abnormal images illustrated in FIG. 3B, types of existing abnormalities can be roughly determined. Even if there is another product line for producing similar products, the occurrence trend of abnormality may vary at each production line because of a subtle difference in the arrangement of the materials, so that it is difficult to predict the abnormality trend in advance. Therefore, in many products, when the production line is initially started, abnormal samples are collected and an occurrence trend of abnormality is analyzed after the production line has become stable.

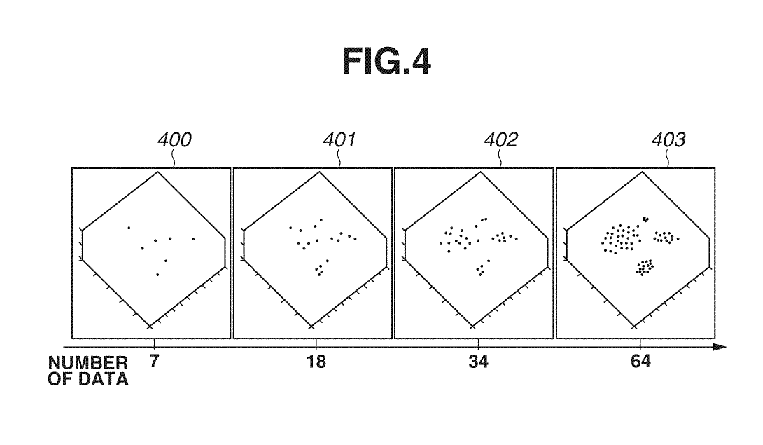

However, at the time of starting the production line, considerable time is required for grasping a type of caused abnormality because abnormal samples may appear less frequently than normal samples. FIG. 4 is a diagram illustrating a state where a data generation trend becomes visible according to an increase in collected data. Herein, for the sake of simplicity, distribution charts in which data is plotted by a three-dimensional feature quantity are illustrated. As illustrated in FIG. 4, a distribution chart 400 is a data distribution of data number of 7 pieces. Further, distribution charts 401 to 403 are data distribution charts of data number of 18 pieces, 34 pieces, and 64 pieces, in which data are increased as time passes.

As illustrated in the distribution charts 400 to 403, it will be easy to presume that approximately four classes exist if the classes are determined at a time when 64 pieces of data are collected. However, as illustrated in the distribution chart 400, at the time of initially starting the production line, it is difficult to estimate that four classes of data trends exist because the number of data is small.

Therefore, in many cases, the user looks at the abnormal data beginning to be accumulated, executes supervising each time while considering whether the data is data of a type similar to that of the other data or data of a new type, and determines a number of abnormality types according to a result of supervising. In such processing, along with an increase in number of data, data that are determined as a same class may be classified into different classes, or data that are determined as different classes may be classified into the same class.

Further, a standard of the label supervised by the user may be changed according to a temporal axis instead of following an absolute index. Furthermore, the data may simply be labelled erroneously by a user who does not grasp the whole picture of data or a user who does not follow a change of the labelling standard. This problem is different from a problem of the erroneous labelling which occurs at a certain ratio in a case where the absolute index is provided. Therefore, the problem cannot be solved even if a noise-robust algorithm is employed for the classifier. In order to cope with the above problem, a system which enables a user to execute labelling or correction to achieve the appropriate classifier is necessary when learning of the classifier is executed according to the acquired data in a case where the user does not know the correct label.

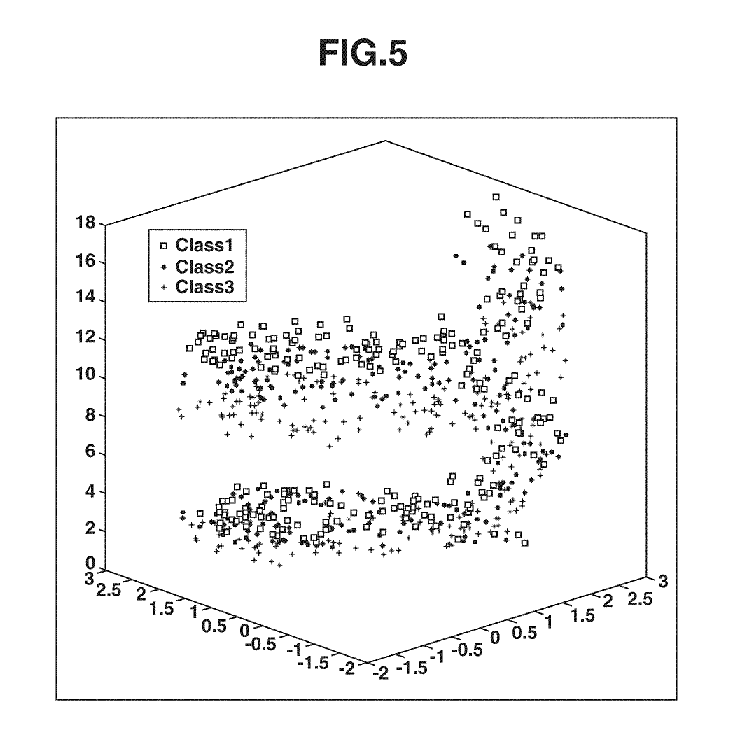

As display which allows the classifier and the user to interactively update a classification standard, a distribution chart can be produced. The distribution chart shows a data distribution of the original feature space or indicates a projection result obtained by the projection in a feature space of equal to or lower than three-dimension through processing such as principal component analysis (PCA) to visualize the data distribution of the original feature space. FIG. 5 is a diagram illustrating an example of a distribution chart 500. In the distribution chart 500 in FIG. 5, data is described in a high-dimensional feature quantity. In the distribution chart 500, a distribution of data classified into three classes, i.e., class 1 to class 3, is visualized and expressed in the three-dimensional feature space through supervised dimensionality reduction.

A method such as a local discriminant information (LDI) or a local fisher discriminant analysis (LFDA) may be used as the supervised dimensionality reduction. By executing dimensionality reduction while saving a regional neighborhood relationship of data belonging to the same class, it is possible to express a feature space in which data of the same class are arranged close to each other and data of different classes are arranged separate from each other.

However, the classification target data may not be simply and completely classified in a feature space. The data may be often visualized as a complex distribution as illustrated in the distribution chart 500 in FIG. 5. In such a visual expression, it is difficult for the user to determine whether data requiring label correction exist, what data to correct, or what type of correction to execute, by simply looking at the data distribution.

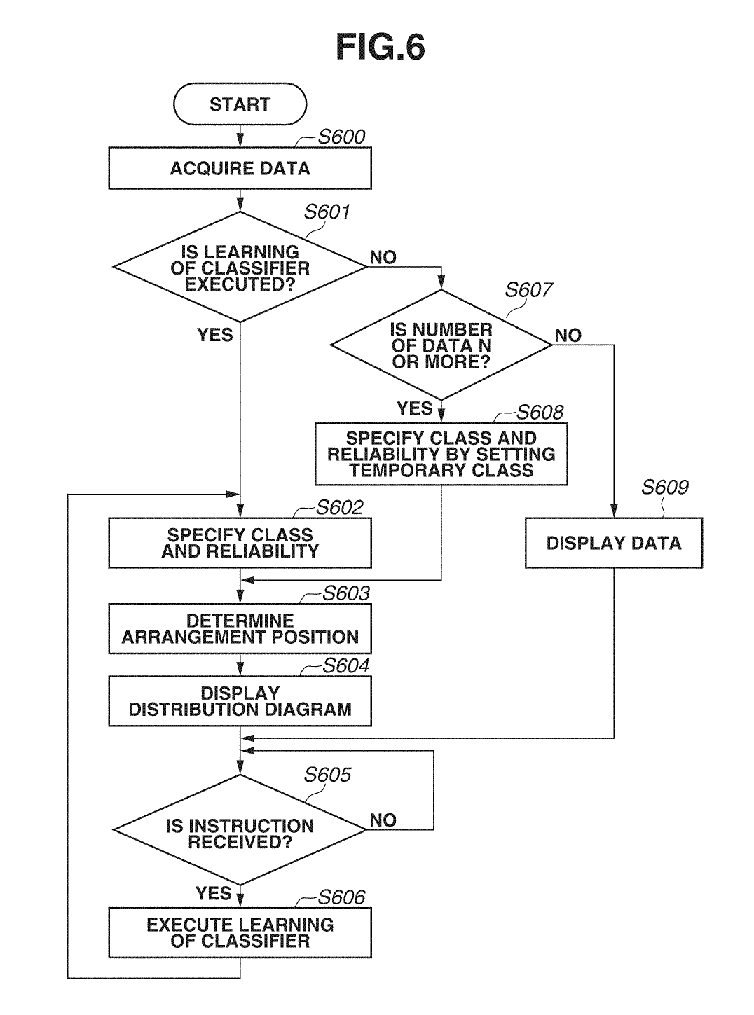

On the contrary, the information processing apparatus 100 according to the present exemplary embodiment executes control to display information appropriate for the user to determine necessary correction when learning of the classifier is executed interactively with the user. FIG. 6 is a flowchart illustrating learning processing executed by the information processing apparatus 100. In step S600, the data acquisition unit 201 acquires image data as a processing target. Then, the data acquisition unit 201 extracts a multi-dimensional feature quantity from the image data. In addition, as another exemplary embodiment, the data acquisition unit 201 may acquire the multidimensional feature quantity together with the image data.

In step S601, the data evaluation unit 202 determines whether learning of the classifier for classifying the data has already been executed by the learning unit 206. If the data evaluation unit 202 determines that learning of the classifier has been executed (YES in step S601), the processing proceeds to step S602. If the data evaluation unit 202 determines that learning of the classifier has not been executed (NO in step S601), the processing proceeds to step S607. In step S602, the data evaluation unit 202 specifies a class to which the data belongs and reliability thereof with respect to all of the input data. Herein, the class corresponds to a type of abnormality. Further, the reliability is a value indicating likelihood that the data belongs to the class, and the reliability can be expressed by probability of the data belonging to the class. The processing in step S602 is an example of class determination processing or reliability determination processing.

Processing of determining a class and reliability will be described below. As illustrated in Formulas 1 and 2, “x” represents a d-dimensional real vector, “c” represents a class number of the entire classification targets, and “y” represents a class label.

x∈R^{d} Formula 1

y∈{1, . . . ,c} Formula 2

The data evaluation unit 202 acquires a distance from unknown-label data x to all of supervised data of the c class. Then, the data evaluation unit 202 retains c-pieces of distances between the unknown-label data x and the nearest data at each class. Since the nearest distance is acquired, a distance can be acquired from the unknown-label data x and the class c. A training sample in which the supervised data and the label are combined is expressed by the formula 3 if the number of supervised data is n.

{(xᵢ,yᵢ)}ᵢ₌₁ⁿ Formula 3

The data evaluation unit 202 calculates a distance from the unknown-label data x to the supervised data xᵢ as the Mahalanobis' distance through the formula 4. In addition, “M” in the formula 4 is a positive-semidefinite matrix.

dist_{M}(x,xᵢ)=(x−xᵢ)^{T}M(x−xᵢ) Formula 4

Then, based on the distance acquired from the formula 4, the data evaluation unit 202 determines a class which the unknown-label data x belongs to. For example, as illustrated in the formula 5, the data evaluation unit 202 determines a class label of the supervised data having a minimum distance, as an estimated label Y(x) of the data x.

Y(x)=y_{arg min}_{ᵢ}_{{(dist}_{_{M}}_{(x,x}_{ᵢ}_{)}} Formula 5

Similarly, the supervised data up to the k-neighborhood of the data x is considered. “k” is less than “n” (k<n). Since the formula 5 indicates the nearest neighborhood, it will be hereinafter expressed as Y₁(x), and the k-neighborhood label is expressed as Yₖ(x). The data evaluation unit 202 acquires a reliability T through the formula 6. The reliability T is set as a value equivalent to a ratio between a value k, and the number of data having the same label as the nearest neighborhood data from among the supervised data in the k-neighborhood.

$$T ( x ) = \frac{{\sum }_{j = 1}^{k} \{ + 1 \text{:} {Y}_{j} ( x ) = {Y}_{1} ( x ) \}}{k} \qquad Formula 6$$

In step S603, based on the class and the reliability determined in step S602, the graph creation unit 203 determines an arrangement position (plotting position) of each data in a data distribution chart to be displayed on the display unit 105. Then, the graph creation unit 203 arranges a dot image indicating each data at a determined arrangement position in the distribution chart. In other words, the graph creation unit 203 creates a distribution chart. In step S604, the display processing unit 204 controls the display unit 105 to display the created distribution chart. This processing is an example of display processing.

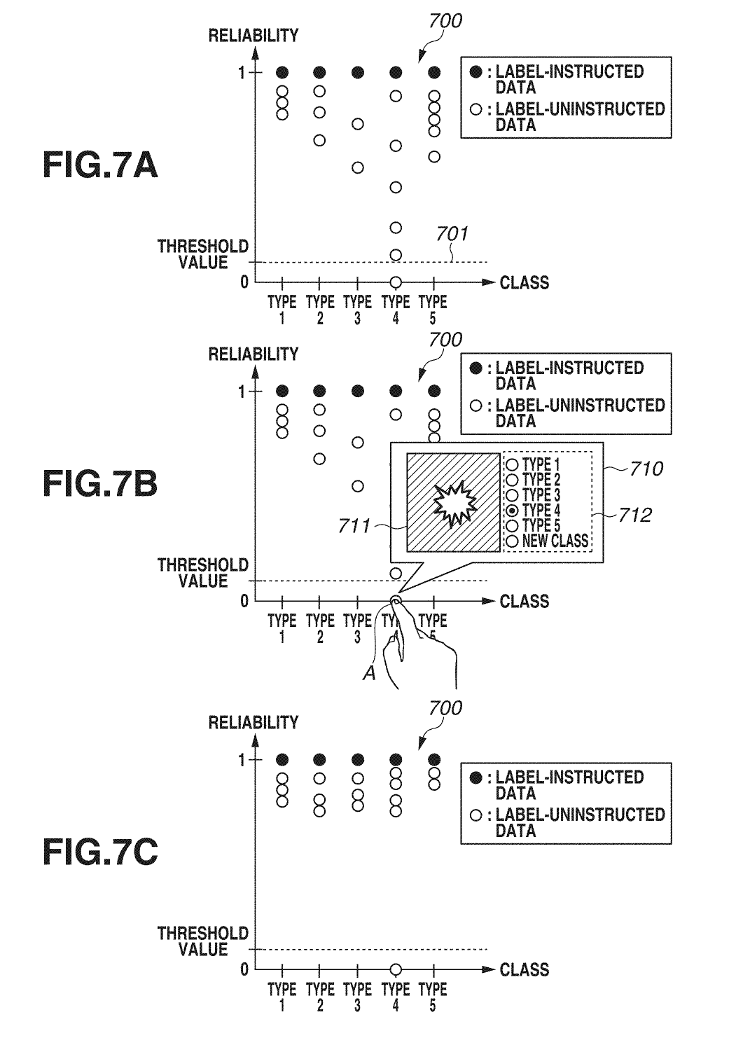

FIG. 7A is a diagram illustrating an example of a distribution chart 700 displayed in step S604. The distribution chart 700 in FIG. 7A is a two-dimensional graph in which a horizontal axis indicates a class type and a vertical axis indicates reliability with respect to the class. In addition, the reliability is normalized to 0 to 1. In the distribution chart 700 in FIG. 7A, data is classified into five classes, so that values corresponding to the five classes are assigned. Further, dot images corresponding to data are plotted in the distribution chart 700. Black dot images correspond to label-instructed data, whereas white dot images correspond to label-uninstructed data. The label-instructed data accord with determination of a class corresponding to the user operation, and is data to which a class label has been instructed (given). The label-uninstructed data is data to which the class label has not been instructed.

As described above, because the information processing apparatus 100 displays the label-instructed data and the label-uninstructed data in different colors such as black and white, the user can easily distinguish between the data in the distribution chart. In addition, because the user can distinguish between both data if the information processing apparatus 100 displays the label-instructed data and the label-uninstructed data in different display forms, a specific display form is not limited to the display form described in the present exemplary embodiment.

In the present exemplary embodiment, it is assumed that classes of all of the label-instructed data are correct, and the reliability of the label-instructed data is set to 1. Because the reliability of all of the label-instructed data is 1, a plurality of dot images overlaps with each other and is displayed at a position of the reliability 1. In the present exemplary embodiment, the information processing apparatus 100 is set such that a correction instruction of the label-instructed data provided from the classifier is not accepted. On the other hand, the label-uninstructed data can take reliability values of 0 to 1. Thus, in the distribution chart 700, a classification class and its reliability of each data as viewed from the learned classifier can be displayed regardless of the data distribution in the original feature space or the visualized feature space.

By checking the distribution chart 700, the user can apply a class label to the label-uninstructed data showing high reliability. On the other hand, with respect to the data showing low reliability, correction of the class level may be necessary. Therefore, the display processing unit 204 compares reliability of each data with a preset reliability threshold value, and displays dot images of data indicating lower reliability than the threshold value in a display form which is different from dot images of data indicating reliability equal to or greater than the threshold value. Specifically, the display processing unit 204 displays the dot images of data indicating lower reliability than the threshold value in an emphasized form such as blinking. Further, the display processing unit 204 displays a reliability threshold value 701. Thus, the information processing apparatus 100 can provide a display that draws the user's attention to data with low reliability.

After the processing in step S604, in step S605, the instruction receiving unit 205 determines whether an instruction for assigning a new class or an instruction for correcting a class is received according to the user operation. This processing is an example of receiving processing. The instruction receiving unit 205 stands ready until the instruction for assigning or the instruction for correcting a class is received. If the instruction is received (YES in step S605), the processing proceeds to step S606.

FIG. 7B is a diagram illustrating a display example of a graphical user interface (GUI) for receiving a user operation. As illustrated in FIG. 7B, when the user selects a dot image having low reliability, the display processing unit 204 displays a pop-up screen 710. In the pop-up screen 710, an image 711 is indicated as original data corresponding to the selected dot image and an option 712 of a class to be allocated to the original data. In the example of FIG. 7B, a new class is displayed as the option 712 in addition to the classes of types 1 to 5 provided already. With this screen, the user can instruct a class label after checking the image 711. For example, if the type 4 is selected with respect to a dot image A, the instruction receiving unit 205 receives an instruction for correcting a label given to the type 4.

In step S606, the learning unit 206 changes the class label according to the instruction received in step S605 and changes the reliability to 1. In this processing, for example, if the type 4 is selected with respect to the dot image A in FIG. 7B, the dot image A becomes label-instructed data of the type 4, and the reliability thereof is set to 1. Further, according to the above change, the learning unit 206 trains the classifier again and updates the classifier.

Then, the learning unit 206 advances the processing to step S602. In this case, in step S602, the data evaluation unit 202 uses the updated classifier and the label-instructed data including the data to which the label is newly instructed in step S606 to determine the class and the reliability with respect to all of the label-uninstructed data again. In other words, the data evaluation unit 202 updates the determination results of the class and the reliability with respect to the label-uninstructed data. This processing is an example of processing for updating the determination results of the class and the reliability of learning data other than learning data relating to the instruction for assigning or the instruction for correcting the class to which the class has not been assigned. Thereafter, in step S603, based on the updated determination results of the class and the reliability, the graph creation unit 203 updates the distribution chart with respect to the label-uninstructed data. Specifically, the graph creation unit 203 appropriately changes the arrangement positions of the dot images corresponding to the label-uninstructed data according to the updated determination results.

Then, in step S604, the display processing unit 204 displays the updated distribution chart. Thus, through the instruction according to the user operation, learning of the classifier and determination of the class and the reliability of the label-uninstructed data are executed, and the distribution chart is updated accordingly. Every time the user operation is executed, the information processing apparatus 100 can repeatedly execute the processing in steps S606, and S602 to S604.

FIG. 7C is a diagram illustrating the distribution chart 700 after update of the classifier and update of the class and the reliability of the label-uninstructed data are executed repeatedly from a state of the distribution chart 700 in FIG. 7A. In FIG. 7C, it can be seen that the reliability of the label-uninstructed data is increased in comparison to the reliability thereof illustrated in FIG. 7A. Thus, through the positional change of dot images in the distribution chart, the information processing apparatus 100 can indicate a state in which reliability of the class with respect to the label-uninstructed data is increased according to the user operation. In other words, the user can easily and visually recognize a state in which the reliability is increased. Because a feedback result is directly provided when the user carries out the supervising operation, it is effective to guide the user to execute input appropriate for improving a separation degree.

As described above, in the information processing apparatus 100 of the present exemplary embodiment, the user may assign a class only with respect to the data of which the class can be clearly determined. On the other hand, with respect to data of which the class has not been determined, learning of the classifier can be executed based on the newly acquired data while determination of the class is suspended. Then, the class may be assigned when the class with respect to the data is clarified.

On the other hand, information relating to classification is not acquired from data at the time when collection of data is started. Because the classifier does not exist in a state where nothing has been learned (NO in step S601), the processing proceeds to step S607. In step S607, the data evaluation unit 202 compares a number of acquired data and a preset data number threshold N.

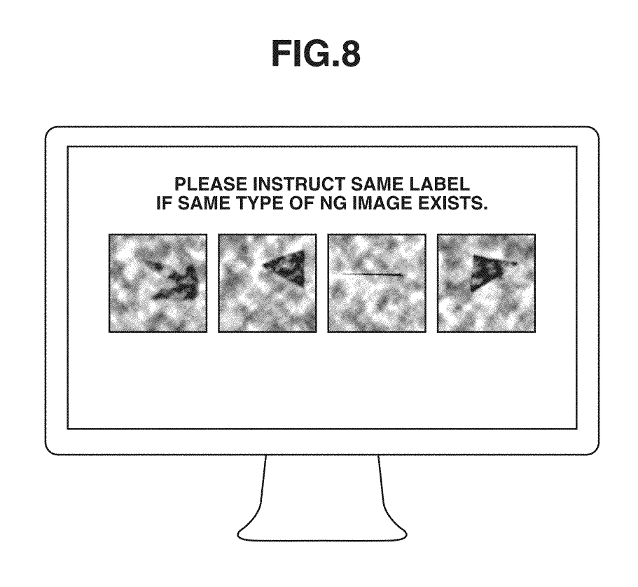

If the data evaluation unit 202 determines that the number of data is N or more (YES in step S607), the processing proceeds to step S608. If the data evaluation unit 202 determines that the number of data is less than N (NO in step S607), the processing proceeds to step S609. In step S609, the display processing unit 204 performs control to display the acquired data, i.e., the image, on the display unit 105. This is because information beneficial to the user cannot be provided even if the data distribution is displayed by executing dimensionality reduction when the number of data is too small. In other words, the data number threshold N is used as a reference therefor. FIG. 8 is a diagram illustrating a display example of the display unit 105 in step S609. As illustrated in FIG. 8, if the number of data is N or less, all pieces of the data (images) are displayed. After the display processing unit 204 executes the processing in step S609, the processing proceeds to step S605.

On the other hand, when the number of data is increased, it will be difficult for the user to determine how many abnormalities and what trend exists because all of data are displayed as illustrated in FIG. 8. Conversely, when the number of data is increased, cluster analysis of data can be easily executed by the classifier even if the data is not supervised.

Therefore, in step S608, the data evaluation unit 202 sets a temporary class to determine a class and reliability with respect to all of data. For example, because there is no instruction label, the data evaluation unit 202 executes non-supervised dimensionality reduction and analyzes a cluster from a data distribution in a low dimension. Specifically, the data evaluation unit 202 performs dimensionality reduction to low dimension through a generally-known method such as principal component analysis (PCA) or locally preserving projection (LPP). Then, as a method of determining the appropriate class number from a data distribution after the dimensionality reduction, the data evaluation unit 202 uses an X-Means method to calculate the labels of all of the non-supervised data and the reliability indicating whether the data belong to these labels. Then, the data evaluation unit 202 advances the processing to step S603. In this case, in step S603, arrangement positions with respect to the label-uninstructed data are determined, and in step S604, the distribution chart with respect to the label-uninstructed data is displayed. In this processing, for example, a distribution chart of only label-uninstructed data in the distribution chart in FIG. 7A is displayed.

As described above, the information processing apparatus 100 of the present exemplary embodiment can display a supervised class and its reliability with respect to the input data when learning of the classifier is executed. With this configuration, the user can easily grasp the latest learning result. In other words, in processing of learning the classifier interactively with the user, the information processing apparatus 100 can display information appropriate for learning the highly precise classifier.

As a first variation example of the first exemplary embodiment, the information processing apparatus 100 may also use the classifier to calculate reliability and display a distribution chart reflecting that reliability also with respect to the label-instructed data. As the user executes supervising by looking at newly input data, in some cases, a classification trend may be shifted to a trend different from the past classification trend. For example, in the abnormality type classification performed at the production site, as feedback with respect to the production line, a user may desire to further classify an abnormality type appearing in large numbers or an abnormality type having wide variations. Further, with respect to an abnormality type class, which the user has taken as an abnormality type to be classified and set a classification standard at the initial start of the production line, along with a change in the occurrence frequency, the user may determine that the subject type does not have to be classified, and it is possible that reliability of the label-instructed data needs to be changed.

The information processing apparatus 100 of the present exemplary embodiment displays the above-described change of reliability on the distribution chart to notify the user about the information. With this information, the user can easily determine whether it is necessary to correct a label with respect to data to which the label has already been assigned. In the present variation example, in step S602, the data evaluation unit 202 also obtains reliability of the instructed class with respect to the label-instructed data in addition to the label-uninstructed data. Then, in step S603, the graph creation unit 203 changes also the arrangement position of the label-instructed data as appropriate according to the calculated reliability. In step S604, the display processing unit 204 performs control to display the distribution chart on which each data are arranged.

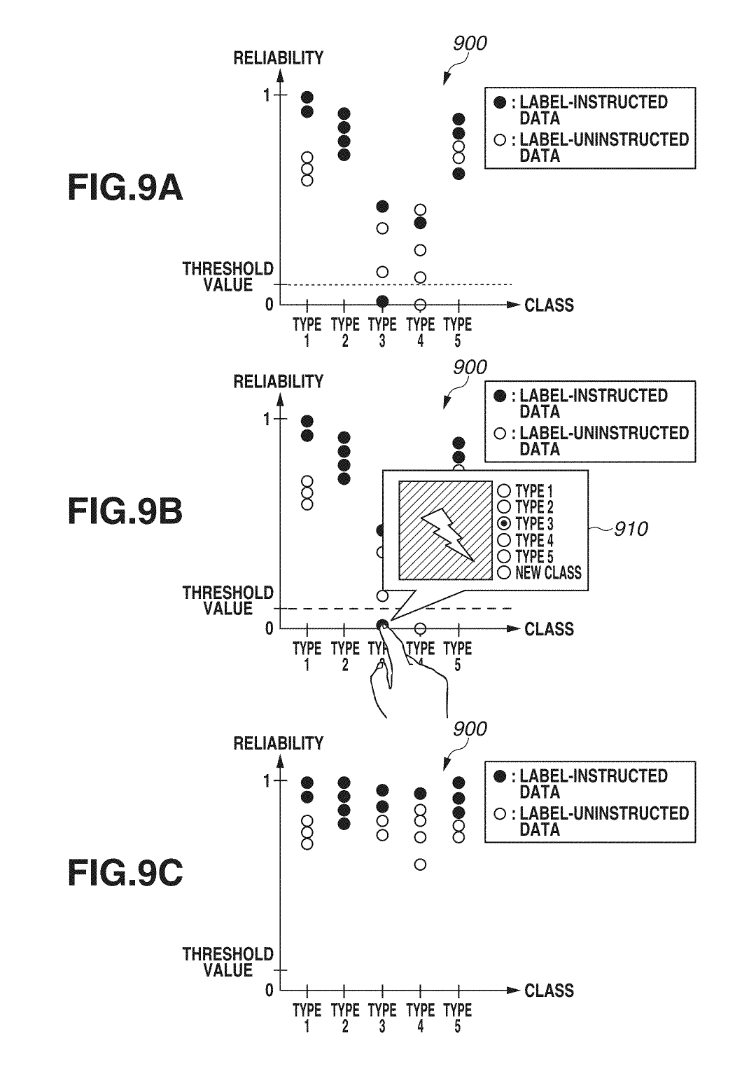

FIG. 9A is a diagram illustrating an example of a distribution chart 900 displayed in step S604. Similar to the distribution chart 700 in FIG. 7A, the distribution chart 900 is a two-dimensional graph, in which a horizontal axis indicates a class and a vertical axis indicates reliability with respect to the class. Also in the distribution chart 900, the label-instructed data and the label-uninstructed data are plotted as black dot images and white dot images respectively. Further, dot images of data indicating lower reliability than the threshold value are displayed in an emphasized manner.

As illustrated in FIG. 9B, when the user selects a dot image, a pop-up screen 910 is displayed. The pop-up screen 910 is similar to the pop-up screen 610. When learning of an appropriate classifier is executed, reliability of all of the data is increased, so that a distribution chart as illustrated in FIG. 9C is displayed. Therefore, it is possible to cause a classifier to learn, from which high reliability can be generally calculated.

As described above, by obtaining reliability of the label-instructed data according to the classifier, the information processing apparatus 100 according to the first variation example can present a possibility of erroneous labelling with respect to the label-instructed data or a possibility of data being classified into new class to the user.

As a second variation example, the data evaluation unit 202 may use a semi-supervised learning when a class and reliability are specified. The semi-supervised learning is a method of executing learning more precisely by using both of labeled data and non-labeled data instead of using only labeled data. With this GUI, it is possible to cause a classifier to learn in such a manner that even information relating to non-labeled data is used efficiently. Further, data can be also displayed on the GUI based on the label and the reliability acquired through the semi-supervised learning. By executing supervision through the above-described method, a workload of the user can be reduced in comparison to concurrently supervising all of data by overviewing the entirety of data.

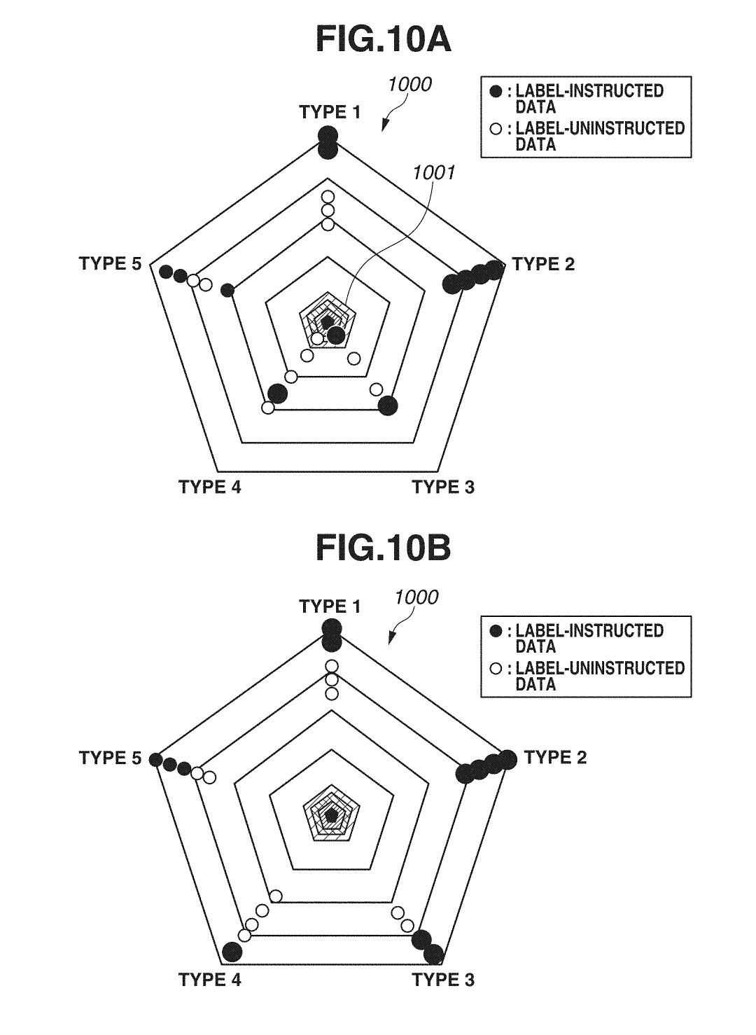

Subsequently, an information processing apparatus 100 according to a second exemplary embodiment will be described. The information processing apparatus 100 according to the present exemplary embodiment displays charts illustrated in FIGS. 10A and 10B. Each axis of a chart 1000 in FIG. 10A or 10B indicates class types, and reliability of respective axes is set to 0 at the center and set to 1 at a circumference of a circle, so that the reliability of respective axes becomes higher in the external direction of the circle. The chart 1000 of the present exemplary embodiment is a graph intended to achieve an expression close to the intuition of a human.

The chart 1000 in FIG. 10A corresponds to the distribution chart 700 in FIG. 7A, and a reliability threshold value 1001 corresponds to the reliability threshold value 701 of the distribution chart 700. Further, the chart 1000 in FIG. 10B corresponds to the distribution chart 700 in FIG. 7C. Thus, the information processing apparatus 100 of the present exemplary embodiment displays the chart 1000 in which the axes indicating reliability of respective class types are arranged in a radial state. The chart 1000 shows that a classifier of each class is caused to learn more favorably as the data gather around in the outer side of the circle, and the classification becomes difficult as the data gather around the center of the circle. With this configuration, data of respective classes forms clusters at positions more separate from each other on the circle if the data are more precisely classified. Accordingly, it is possible to display data according to the intuition of the user.

In addition, display content of the chart 1000 or processing relating to display in the present exemplary embodiment is similar to the display content or the processing relating to display of the distribution chart described in the first exemplary embodiment. Further, the configuration and the processing of the information processing apparatus 100 of the present exemplary embodiment other than the above are similar to those of the information processing apparatus 100 of the first exemplary embodiment.

As a variation example of the second exemplary embodiment, the graph creation unit 203 may determine the arrangement order of the axes indicating classes or an angle between the axes based on a similarity between the classes as a reference. Specifically, the graph creation unit 203 determines the arrangement order of the axes in such a manner that corresponding axes are arranged closer to each other as the similarity becomes higher, and the corresponding axes are arranged more separate from each other if the similarity becomes lower. Further, the graph creation unit 203 makes an angle between corresponding axes smaller if the similarity becomes higher.

Hereinafter, a calculation method of the similarity (distance) between the above-described classes will be described. In the example in FIG. 10A (10B), because the chart has five class axes, the graph creation unit 203 acquires the similarities of respective axes of class axis IDs 1 to 5. The similarity can be defined by an average value of the distances between data that belong to respective classes in the original feature space. In other words, data close to each other in the original feature space belong to similar classes, and classes of data away from each other are not similar to each other. Therefore, the graph creation unit 203 acquires the average value of all of distances between data belonging to respective classes in the original feature space through the formula 7. In addition, the formula 7 is a formula for acquiring the average value of distances between all of data of classes 1 and m (1<c, m<c).

$$D ( l , m ) = \frac{1}{{n}_{l} {n}_{m}} {\sum }_{b : {y}_{b = l}} {\sum }_{a : {y}_{a = l}} {dist}_{M} ( {x}_{a} , {x}_{b} ) \qquad Formula 7$$

Then, the data evaluation unit 202 acquires a c-dimensional similarity vector Gl through the formula 8.

$${G}_{l} = {\{ \frac{1}{D ( l , m )} \}}_{m = 1}^{c} \qquad Formula 8$$

Similar to the formula 8, a similarity matrix of C-pieces of classes including own class with respect to the C-pieces of classes can be expressed by the formula 9.

G={Gₗ}ₗ₌₁^{c},Gₗ∈R^{c}, c>>1 Formula 9

Further, the data evaluation unit 202 sets the dimension to a two-dimension in order to visualize data. If a dimension at dimensionality reduction is q-dimension, a value g is calculated by the formula 10. Herein, an embedded matrix B is defined by the formula 11.

g={gₗ}ₗ₌₁^{c}, g=BGₗ∈R^{q} Formula 10

B∈R^{q×c}, 1≤q<<c Formula 11

Next, methods of calculating the embedded matrix B will be described. The embedded matrix B to be calculated is referred to as B*, and the embedded matrix B* is defined by the formula 12 through a similarity matrix W that describes a rule of making the axes close to each other.

$$Formula 12$$

$${B}^{*} = {arg min}_{B ∈ {R}^{q \times c}} [ {\sum }_{l , m = 1}^{c} {‖ {BG}_{l} - {BG}_{m} ‖}^{2} {W}_{l , m} ] subject to ∀ {G}_{l} ∈ G ; {‖ {BG}_{l} ‖}^{2} = 1$$

Herein, an element W_{1,m} of the similarity matrix W is a matrix that describes the rule for making the feature quantities close to each other, and the element W_{1,m} may be set as a function that takes 1 to make the first and the m-th features close to each other, and takes 0 to make the first and the m-th features away from each other. In other words, through the formula 12, the embedded matrix B* is calculated in such a manner that a distance after dimensionality reduction becomes a minimization target when the element W_{1,m} is 1, and the distance is ignored when the element W_{1,m} is 0.

A value intermediate between 0 to 1 may be set if priority of making the feature quantities close to each other is desirably changed depending on a target. Examples of the element W_{1,m} are expressed by the formulas 13 and 14.

$$\begin{matrix}{W}_{l , m} = \{ \begin{matrix}1 & if {G}_{l} ∈ kNN ( {G}_{m} ) or {G}_{m} ∈ kNN ( {G}_{l} ) k ∈ N \\ 0 & otherwise\end{matrix} & Formula 13 \\ {W}_{l , m} = exp ( \frac{- {‖ {G}_{l} - {G}_{m} ‖}^{2}}{{γ}^{2}} ) γ > 0 & Formula 14\end{matrix}$$

In the formula 13, as to whether the element W_{1,m} is 0 or 1 is determined based on whether a vector Gₗ exists in the k-neighborhood of a vector Gₘ in the n-dimensional feature space. In the formula 14, a value calculated based on a distance defined by a constant γ is set as the element W_{1,m}.

Subsequently, an information processing apparatus 100 according to a third exemplary embodiment will be described. In the information processing apparatus 100 of the present exemplary embodiment, a system which allows the user to use a droplet-like metaphor for performing interaction with the GUI described in the second exemplary embodiment is introduced to the GUI, so that the user can operate data more intuitively. In the above-described exemplary embodiments, reliability regarded as an indicator of difficulty of data classification is displayed as a graph. In the information processing apparatus 100 of the present exemplary embodiment, a class that can be completely classified by a preset reliability threshold value is expressed as a droplet that indicates a classified area. On the other hand, if data having reliability with respect to one class equal to or less than a threshold value which has a possibility of being classified into another class exists, the information processing apparatus 100 displays connected droplets expressing a plurality of classes to which the data might belong.

A method of determining the arrangement positions of the label-instructed data and the label-uninstructed data, and specifying the classes and the reliability of respective data can be realized similar to the second exemplary embodiment. By using the droplet-like metaphor for design of the GUI of the present exemplary embodiment, performance of the learned classifier can be visualized more directly in comparison to the case of the second exemplary embodiment.

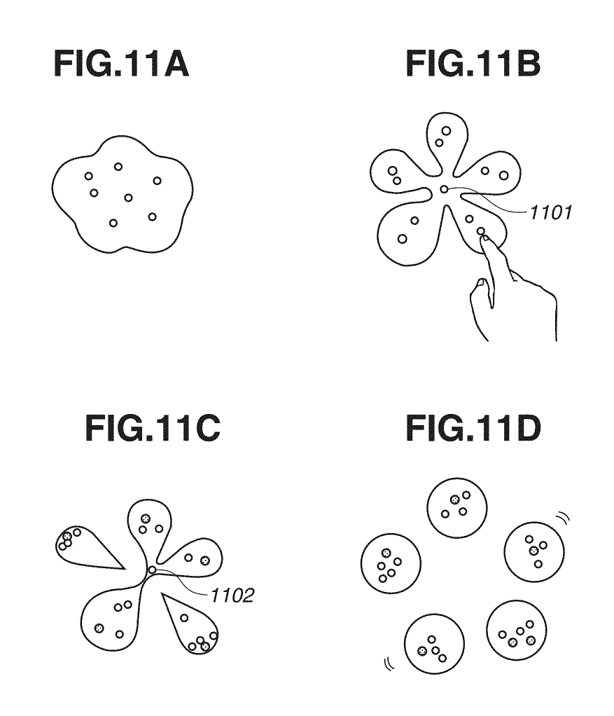

A flow of gradually learning the classifier according to an increase of input data will be described with reference to FIGS. 11A to 11D. In the initial state, a label is not assigned to any of the input data. In this case, as described in the first exemplary embodiment, the display processing unit 204 displays an input image as illustrated in FIG. 8 until the number of data input thereto becomes the data number threshold value N or more.

Then, when the number of input data has become the data number threshold value N or more, the data evaluation unit 202 executes dimensionality reduction for initial display through non-supervised dimensionality reduction. Then, the graph creation unit 203 determines a data distribution. In the above state, because the class number is unknown, the data evaluation unit 202 executes dimensionality reduction to reduce the dimension to a low-dimension through a generally-known method such as principal component analysis (PCA) or locally preserving projection (LPP). Then, the graph creation unit 203 determines initial arrangement of data by using that result. At this time, the label is not assigned to the data, and a class to which the input data belongs has not been determined. In the above state, as illustrated in FIG. 11A, the display processing unit 204 arranges all of the input data at the positions within a droplet that indicates one cluster. In other words, the display processing unit 204 displays data by grouping all of data into one group.

Thereafter, the classifier is gradually learning when the data is supervised according to the user operation. For example, after supervising of five classes is performed, a shape of the droplet in FIG. 11A is changed to a shape in which five droplets corresponding to the five classes are connected at the center as illustrated in FIG. 11B. If one data of unknown class exist, as illustrated in FIG. 11B, five droplets are not separated completely but connected at a position of a dot image 1101 corresponding to the one data. For example, the dot image 1101 corresponds to data having the reliability equal to or less than the reliability threshold value.

After the user executes instruction and correction of the classes continuously and repeatedly, the data can be reliably classified with respect to two classes from among the five classes although one data still have a possibility of being classified into any one of three classes. In this case, as illustrated in FIG. 11C, two droplets corresponding to two classes are separated completely, while droplets corresponding to remaining three classes are connected at a position of a dot image 1102 corresponding to data having a possibility of being classified into any of the three classes. Then, when reliability of all of data has reached the threshold value or more, as illustrated in FIG. 11D, the droplets are separated to five droplets corresponding to five classes. As described above, the user can easily grasp a state of data classified by the classifier from a separation state of the droplets.

Further, in the present exemplary embodiment, because priority is given to a visual effect, the information processing apparatus 100 arranges dot images corresponding to respective data according to a rule that the data are arranged within a predetermined width from the reliability axes of classification classes. However, more simply, the dot images corresponding to data may be arranged similar to that of the second exemplary embodiment.

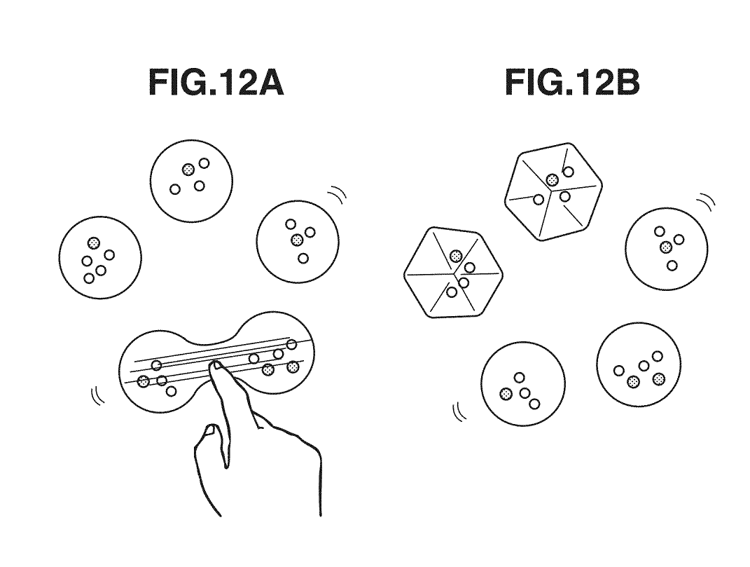

As described above, the information processing apparatus 100 of the present exemplary embodiment allows the user to intuitively and simply interact with the GUI by using the droplet-like metaphor. FIGS. 12A and 12B are diagrams illustrating examples of interaction operations. There is a case where the user would like to relabel the classes to which different class labels have been initially assigned to the same class during the classification operation. In this case, as illustrated in FIG. 12A, the user selects droplet areas representing the classes and executes the operation of connecting the droplets area by using a pointer. In response to the above operation, the information processing apparatus 100 integrates the plurality of classes corresponding to the droplets on which the connection operation is executed into one class. The user also executes operation of dividing a droplet when one class is separated into two classes. In response to the above operation, the information processing apparatus 100 divides the class of data that belong to the droplet on which the division operation is executed into two droplets, and allocates respective data to the two classes.

Further, the classifier may be entirely changed according to update of a class of data or input of new data, however, there is a case where the user would like to stop updating the parameters relating to a classifier of a part of learned classes. In this case, as illustrated in FIG. 12B, the information processing apparatus 100 changes display of the droplet to a piece of ice. With this configuration, the user can intuitively understand that the parameter will not be updated any further. Further, the configuration and the processing of the information processing apparatus 100 of the present exemplary embodiment other than the above are similar to those of the information processing apparatus 100 of the other exemplary embodiments.

While the present invention has been described in detail with reference to the preferred exemplary embodiments, the present invention is not limited to the above-described specific exemplary embodiments, and many variations and modifications are possible within the essential spirit of the present invention described in the scope of appended claims.

### Other Exemplary Embodiments

The present invention can be realized in such a manner that a program for realizing one or more functions according to the above-described exemplary embodiments is supplied to a system or an apparatus via a network or a storage medium, so that one or more processors in the system or the apparatus reads and executes the program. Further, the present invention can be also realized with a circuit (e.g., application specific integrated circuit (ASIC)) that realizes one or more functions.

According to the present invention, in the processing of causing a classifier to learn interactively with a user, it is possible to display information appropriate for causing a highly precise classifier to learn.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-034901, filed Feb. 27, 2017, which is hereby incorporated by reference herein in its entirety.

What is claimed is:

1. An information processing apparatus comprising:
a class determination unit configured to determine a class to which learning data belong, based on a feature quantity of learning data used for learning of a classifier;
a reliability determination unit configured to determine reliability with respect to the class determined by the class determination unit; and
a display processing unit configured to display a distribution chart of learning data in which images indicating the learning data are arranged at positions corresponding to the class and the reliability on a display unit.

2. The information processing apparatus according to claim 1, further comprising:
a receiving unit configured to receive an assignment instruction for assigning a class with respect to one piece of learning data from a user;
wherein the class determination unit updates a determination result of a class to which learning data other than the learning data relating to the assignment instruction belongs, based on the assignment instruction;
wherein the reliability determination unit updates a determination result of reliability with respect to learning data other than the learning data relating to the assignment instruction, based on the assignment instruction; and
wherein the display processing unit updates the distribution chart based on the determination results of the class and the reliability updated according to the assignment instruction.

3. The information processing apparatus according to claim 2,
wherein the class determination unit updates the determination result of a class to which learning data other than the learning data relating to the assignment instruction, to which a class is not assigned, belongs, based on the assignment instruction; and
wherein the reliability determination unit updates the determination result of reliability with respect to learning data other than the learning data relating to the assignment instruction, to which a class is not assigned, based on the assignment instruction.

4. The information processing apparatus according to claim 1, wherein the display processing unit displays a distribution chart having an axis indicating a type of the class.

5. The information processing apparatus according to claim 4, wherein the display processing unit displays a two-dimensional distribution chart having axes indicating a type of the class and the reliability.

6. The information processing apparatus according to claim 4, wherein the display processing unit displays a chart that shows a type of the class as an axis, as the distribution chart.

7. The information processing apparatus according to claim 4, wherein the display processing unit determines an arrangement position of the axis based on a similarity between classes.

8. The information processing apparatus according to claim 1, wherein the display processing unit displays images of learning data having the reliability lower than a threshold value, in a display form different from a display form of images of learning data having the reliability equal to or greater than the threshold value.

9. The information processing apparatus according to claim 1, wherein the display processing unit displays images indicating learning data to which a class is determined in a display form different from a display form of images indicating learning data to which a class is not determined.

10. The information processing apparatus according to claim 1, wherein the reliability determination unit determines the reliability based on probability of the learning data belonging to the class.

11. The information processing apparatus according to claim 1, wherein the display processing unit groups and displays images indicating the learning data based on the reliability and the class.

12. The information processing apparatus according to claim 1, wherein the class corresponds to a type of abnormality.

13. An information processing method executed by an information processing apparatus comprising:
determining a class to which learning data belongs based on a feature quantity of the learning data;
determining reliability with respect to the determined class; and
displaying images indicating the learning data on a display unit at positions according to the class and the reliability.

14. The information processing method according to claim 13, further comprising,
receiving an assignment instruction for assigning a class with respect to one piece of learning data from a user,
wherein, in the determination of a class, a determination result of a class to which learning data other than the learning data relating to the assignment instruction belongs, is updated based on the assignment instruction;
wherein, in the determination of reliability, a determination result of reliability with respect to learning data other than the learning data relating to the assignment instruction is updated based on the assignment instruction; and
wherein, in the displaying, the distribution chart is updated based on the determination results of the class and the reliability updated according to the assignment instruction.

15. The information processing method according to claim 13,
wherein, in the determination of a class, the determination result of a class to which learning data other than the learning data relating to the assignment instruction to which a class is not assigned, belongs, is updated based on the assignment instruction; and
wherein, in the determination of reliability, the determination result of reliability with respect to learning data other than the learning data relating to the assignment instruction to which a class is not assigned, is updated based on the assignment instruction.

16. The information processing method according to claim 13, wherein, in the displaying, a distribution chart having an axis indicating a type of the class is displayed.

17. The information processing method according to claim 16, wherein, in the displaying, a two-dimensional distribution chart having axes indicating a type of the class and the reliability is displayed.

18. The information processing method according to claim 16, wherein, in the displaying, a chart that shows a type of the class as an axis is displayed as the distribution chart.

19. The information processing method according to claim 16, wherein, in the displaying, an arrangement position of the axis is determined based on a similarity between classes.

20. A non-transitory computer-readable non-volatile storage medium storing a program for causing a computer to execute respective steps of an information processing method, the information processing method comprising:
determining a class to which learning data belongs based on a feature quantity of the learning data;
determining reliability with respect to the class determined by the class determination;
displaying images indicating the learning data on a display unit at positions corresponding to the class and the reliability.
